(19) United States
(12) Patent Application Publication
(10) Pub. No.: US 2017/0348869 A1
(43) Pub. Date: Dec. 7, 2017

(54) SHEET PROCESSING MACHINE AND METHOD OF MANUFACTURING THEREOF

(71) Applicant: Nilesh Dhirajlal Parmar, Rajkot, Gujarat (IN)

(72) Inventor: Nilesh Dhirajlal Parmar, Rajkot, Gujarat (IN)

(21) Appl. No.: 15/542,056

(22) PCT Filed: Jan. 1, 2016
(86) PCT No.: PCT/IB2016/050002

§ 371 Date: Jul. 6, 2017

(30) Foreign Application Priority Data
Jan. 7, 2015 (IN) 66/MUM/2015

(51) Int. Cl. B26D 7/01; B26D 9/00; B26F 1/02; B42C 19/02

(52) U.S. Cl. CPC B26D 7/01; B42C 19/02; B26D 9/00; B26F 1/02

(57) ABSTRACT

A machine and a method of manufacturing the machine are provided. The machine comprises a sensor, a plurality of tools and a processor. The sensor is configured to detect a sheet of a bundle of sheets. The bundle of sheets includes at least a first sheet having a first edge and a second sheet having a second edge, and the sheet is any one of the first sheet and the second sheet. The plurality of tools removably is disposed in a tool housing. Each tool of the plurality of tools corresponds to at least an operation of a plurality of operations, and each tool of the plurality of tools is arranged to perform the operation on the sheet. The processor configured to position the sheet and to selectively actuate at least one tool of the plurality of tools to cause performance of at least one operation at a first location on the first sheet and at a second location on the second sheet, and wherein the first location and second location are determined by the processor based on a first input to obliquely aligned the first edge and the second edge upon aligning the first location and second location.

### CROSS REFERENCES

The underlying concepts, but not necessarily the language, of the Indian provisional patent application number 66/MUM/2015 filed on Jan. 7, 2015 and that this application claims benefit of the aforementioned provisional application and draws priority from the aforementioned application and contents of said provisional specification are incorporated herein by reference in their entirety as if fully disclosed in this specification.

### TECHNICAL FIELD

The present subject matter relates to a sheet processing machine and method of manufacturing the machine. More specifically, the subject matter relates to a machine to process a bundle of sheets. Even more specifically, the subject matter relates to a method and a machine for punching, folding, laminating, and creasing sheets, card board, cloth or any material that is required to be bound. The subject matter also relates to a method of manufacturing the aforesaid machine.

### BACKGROUND

Post printing production plays a critical role in final presentation of printed material. Post printing production involves a number of operations for example, folding or creasing, punching etc. Conventionally post printing production requires high experience, patience and skills. Small mistakes during the post printing production process could result in the wastage of entire lot of the printed material. For example, when post printing production involves binding a book or books, miss alignment of one or few pages could result in the wastage of entire book, or even more so entire-lot of the books. Similarly, when the post printing production involves folding or creasing of printed material—for example, leaflets, posters, covers etc.—one incorrect fold or crease could result in waste of the printed material. A leaflet may require a number of folds and/or creases and/or multiple punching at different locations of the leaflet. For each fold and/or crease and/or punch requires setting up of the leaflet by a human which increases possibility of error and hence wastage. Because the process requires high skills, experience and time, the process is extremely expensive and error prone. Despite of these limitations replacing expertise, skills and experience with other relatively low cost solution is a challenge.

### SUMMARY

Before the present subject matter is described in further detail, it is to be understood that the subject matter is not limited to the particular embodiments described, and as such may, of course, vary. It shall become abundantly clear after reading this specification, that the subject matter may, without departing from the spirit and scope of the subject matter, also be practiced in other than the exemplified embodiments. For example, other embodiments than the exemplified embodiments are possible, which may vary in shape or size. It shall also become clear that the drawings may not to the scale. In some other examples, the method may vary to include some additional block or may be practiced in the order different than the order of the blocks discussed in this specification. It is also to be understood that the terminology used herein is for the purpose of describing particular embodiments only, and is not intended to be limiting. It must be noted that as used herein, the singular forms “a”, “an”, and “the” include plural referents unless the context clearly dictates otherwise. The present subject matter provides solution to a number of problems, including but not limited to the problems discussed below.

The present subject matter provides solution to the above and other problems. The present subject matter provides a sheet processing machine and method of manufacturing the machine that overcomes the above and other limitations. The present subject matter also provides a method of manufacturing the machine.

According to an aspect, the machine comprises: a sensor configured to detect a sheet of a bundle of sheets, wherein the bundle of sheets includes at least a first sheet having a first edge and a second sheet having a second edge, and the sheet is any one of the first sheet and the second sheet; a plurality of tools removably disposed in a tool housing and each tool of the plurality of tools corresponds to at least an operation of a plurality of operations, and each tool of the plurality of tools is arranged to perform the operation on the sheet; and a processor configured to position the sheet and to selectively actuate at least one tool of the plurality of tools to cause performance of at least one operation at a first location on the first sheet and at a second location on the second sheet, and wherein the first location and second location are determined by the processor based on a first input to obliquely aligned the first edge and the second edge upon aligning the first location and second location. According to one embodiment, the machine further comprises a plurality of rollers configured to receive and position the sheet based on detection of the sheet by the sensor and the first input and the processor is configured to cause at least one roller of the plurality of rollers to roll to position the sheet. According to another embodiment, the machine further comprises a feeder configured to receive the bundle of sheets, and the feeder is arranged to selectively feed the sheet for positioning. In one embodiment, the sensor includes any one or a combination of: an optical sensor, an electrical sensor, a mechanical sensor, and a sonic sensor. In a second embodiment, the plurality of tools includes any one or a combination of a punching tool, a window cutting tool, a laminator, a creasing tool, a folding tool, and a stapler. In a third embodiment, the plurality of operations includes any one or a combination of: a window cutting operation, a punching operation, a stapling operation, a creasing operation, a folding operation, and a lamination operation. In a fourth embodiment, the processor is configured to receive the first input and wherein the first input characterizes the bundle of sheets and sheets thereof. In a fifth embodiment, the processor is configured to receive the first input from a remote location through any one of a wired communication, a wireless communication and a combination thereof. In a sixth embodiment, the machine further comprises a control panel, wherein the control panel is coupled to the processor and the control panel is configured to receive the first input.

According to another aspect the present subject matter provides a method for manufacturing a machine. The method comprises configuring a sensor to detect a sheet of a bundle of sheets, wherein the bundle of sheets includes at least a first sheet having a first edge and a second sheet having a second edge, and the sheet is any one of the first sheet and the second sheet; disposing removably a plurality of tools in a tool housing and each tool of the plurality of tools corresponds to at least an operation of a plurality of operations, and arranging each tool of the plurality of tools to perform the operation on the sheet; and configuring a processor to position the sheet and to selectively actuate at least one tool of the plurality of tools to cause performance of at least one operation at a first location on the first sheet and at a second location on the second sheet, and wherein the first location and second location are determined by the processor based on a first input to obliquely aligned the first edge and the second edge upon aligning the first location and second location. In one embodiment, the method comprises configuring a plurality of rollers to receive and position the sheet based on detection of the sheet by the sensor and the first input and configuring the processor to cause at least one roller of the plurality of rollers to roll to position the sheet. In a second embodiment, the method further comprises providing a feeder to receive the bundle of sheets, and arranging the feeder to selectively feed the sheet for positioning; and configuring the sensor includes configuring any one or a combination of: an optical sensor, an electrical sensor, a mechanical sensor, and a sonic sensor. In a third embodiment, disposing removably the plurality of tools includes disposing any one or a combination of a punching tool, a window cutting tool, a laminator, a creasing tool, a folding tool, and a stapler and wherein the plurality of tools corresponds to a plurality of operations in that: the punching tool corresponds to a punching operation; a window cutting tool corresponds to a window cutting operation; a laminator corresponds to a lamination operation; a creasing tool corresponds to a creasing operation; a folding tool corresponds to a folding operation; and a stapler corresponds to a stapling operation. In a fourth embodiment, the method includes configuring the processor to receive the first input and wherein the first input characterizes the bundle of sheets and sheets thereof. In a fifth embodiment, the method includes configuring the processor to receive the first input through any one of a wired communication, a wireless communication and a combination thereof and coupling a control panel with the processor, wherein the control panel is configured to receive the first input. In one embodiment, the method includes configuring the processor to receive the first input from a remote location.

### BRIEF DESCRIPTION OF DRAWINGS

The subject matter shall now be described in more details with reference to accompanying figures wherein:

FIG. 1 shows a machine according to a prior art;

FIG. 2 shows a conceptual representation of a machine according to an embodiment of the present subject matter;

FIG. 2(a) shows a non-linear profile of a binding edge of a bundle of sheets according to an embodiment of the present subject matter;

FIG. 2(b) shows a comparison of binding a bundle of sheets according to the present subject matter and according to a prior art;

FIG. 2(c), FIG. 2(d) and FIG. 2(e) illustrate some of the possible embodiments of punching and creasing of one or more sheets of a bundle of sheets according to the present subject matter;

FIG. 2(f) shows a stapling machine according to an embodiment;

FIG. 2(g) shows a schematic representation of a control panel according to an embodiment of the present subject matter;

FIG. 3(a) and 3(b) show an embodiment of a machine according to an embodiment of the present subject matter;

FIG. 3(c) shows an embodiment of a machine according to another embodiment of the present subject matter;

FIG. 4 shows an embodiment of a block diagram of a machine according to an embodiment of the present subject matter; and

FIG. 5 shows an embodiment of a method of manufacturing a punching and creasing machine according to the present subject matter.

### DESCRIPTION OF DRAWINGS

It should be understood, that for the purpose of clarity and brevity some feature or some figures may have been exaggerated and may be not to the scale. The solution of the present subject matter, for better clarity, is being discussed with reference to the problems associated with an existing art which is discussed in the Indian patent application number 2997/MUM/2012.

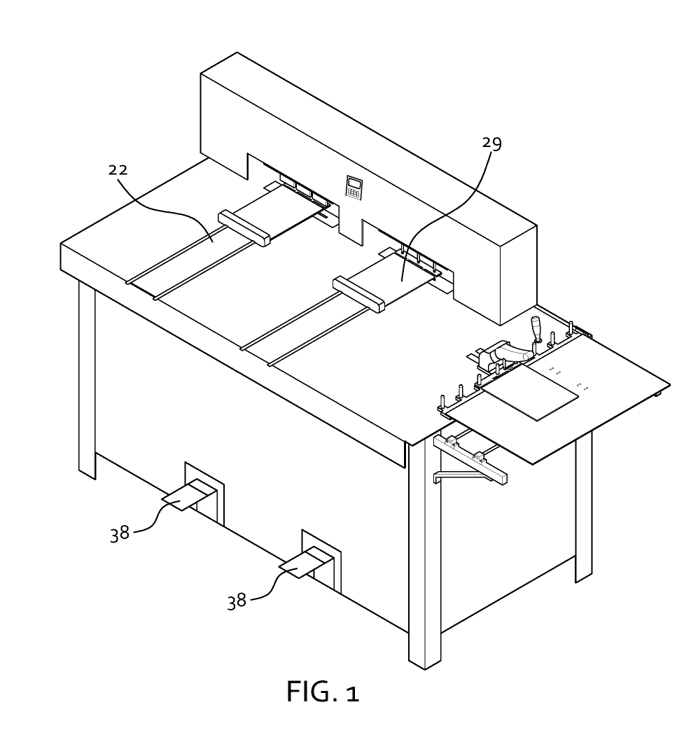

The applicant of the present subject matter is also the applicant of the Indian patent application number 2997/MUM/2012 and corresponding International Patent Application number PCT/IN2012/000767, while these applications provide a solution which enables cutting and punching of a sheet of a bundle of sheets in such a manner that when the sheets are bound together, result in a book which gives a relatively flat outlook when the book is opened. The solution of the referred application is shown in the FIG. 1. The solution of FIG. 1 provides guide that adjust its positions based on inputs received at a processor and a user must put the sheet between the guides at the cutting assembly 22, after placing the sheet the user must using paddle switches 38 cause window cutting die to fall on the sheet. All the above actions must be performed by the user for each sheet of the bundle at the cutting assembly 22. The user then takes the bundle of sheets to a laminator (not shown), for thermal lamination and each is laminated by the user one by one. Once lamination is complete, the use must bring back the sheets at the punching assembly 29 for punching holes. The user must again provide one sheet at a time for punching holes at the punching assembly 29. The guide of punching assembly 29 adjusts itself one by one after each operation of punching and the user, similar to cutting operation, must supply each sheet and cause punching of hole using the paddle switches 38.

The solution of the FIG. 1 is extensively time consuming and is prone to human errors as positioning of sheets between the guides depends on human experts. Further, production cost and time involved using the solution of FIG. 1 is high and therefore need improvements to that effect. Further cost of the machine of FIG. 1 and space occupied by it are considerably higher as it requires two separate set of assemblies namely the cutting assembly 22 and punching assembly 29. In addition, the machine of FIG. 1 requires separate set up for laminating paper which is further adds to the cost and the space. Reducing size of the machine is a challenge because; each of the assembly requires different set of tools, corresponding motors and set of commands. The machine of FIG. 1 requires feeding of the sheets in different assemblies—e.g. cutting assembly 22, punching assembly 29 and laminator—by a user at least for as many numbers of times as are the number of operations desired on the sheet. The machine is not capable of performing a number of same operations at different locations the sheet.

The present subject matter solves the above and other problems. More details of the problems and solutions provided by the present subject matter shall become clearer in the subsequent discussion.

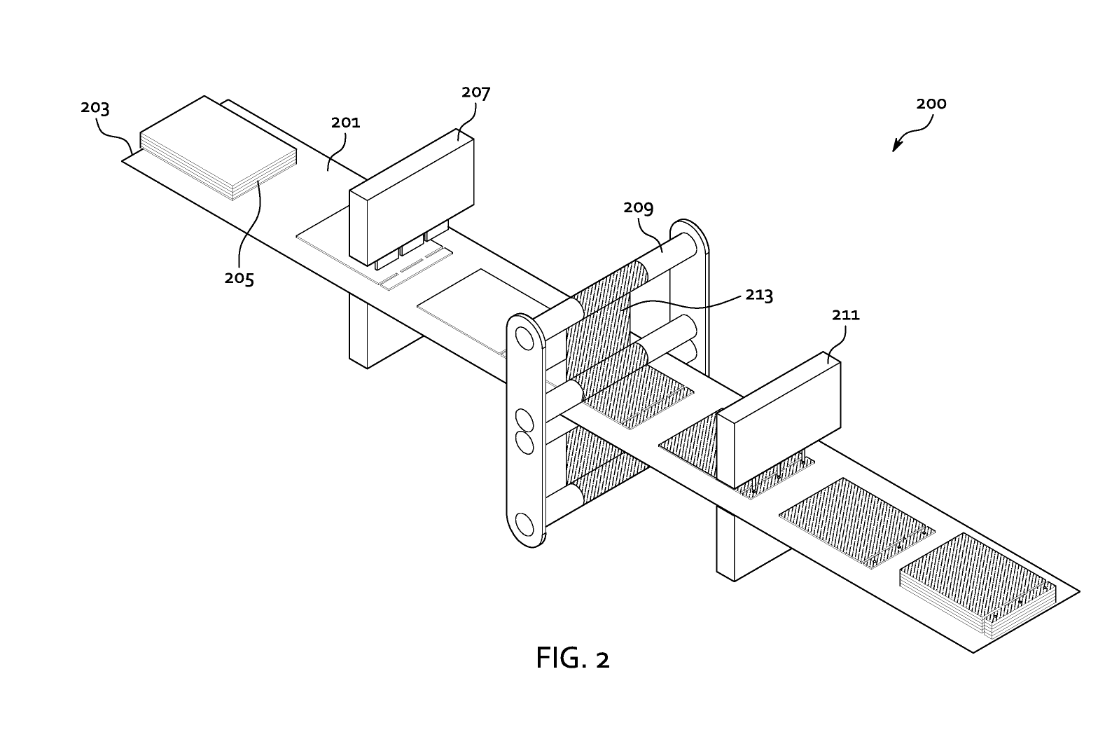

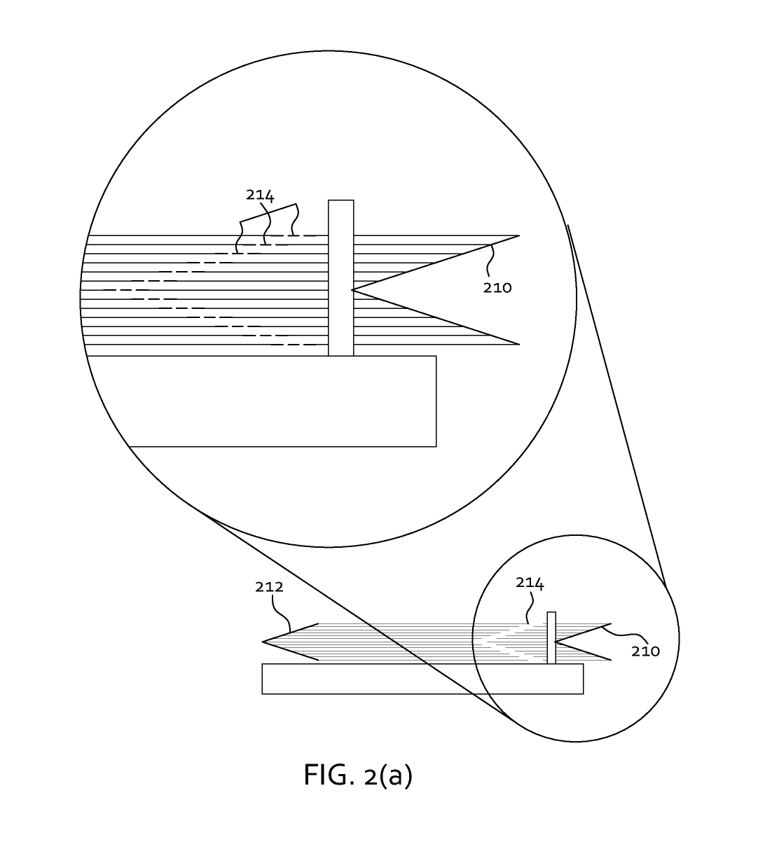

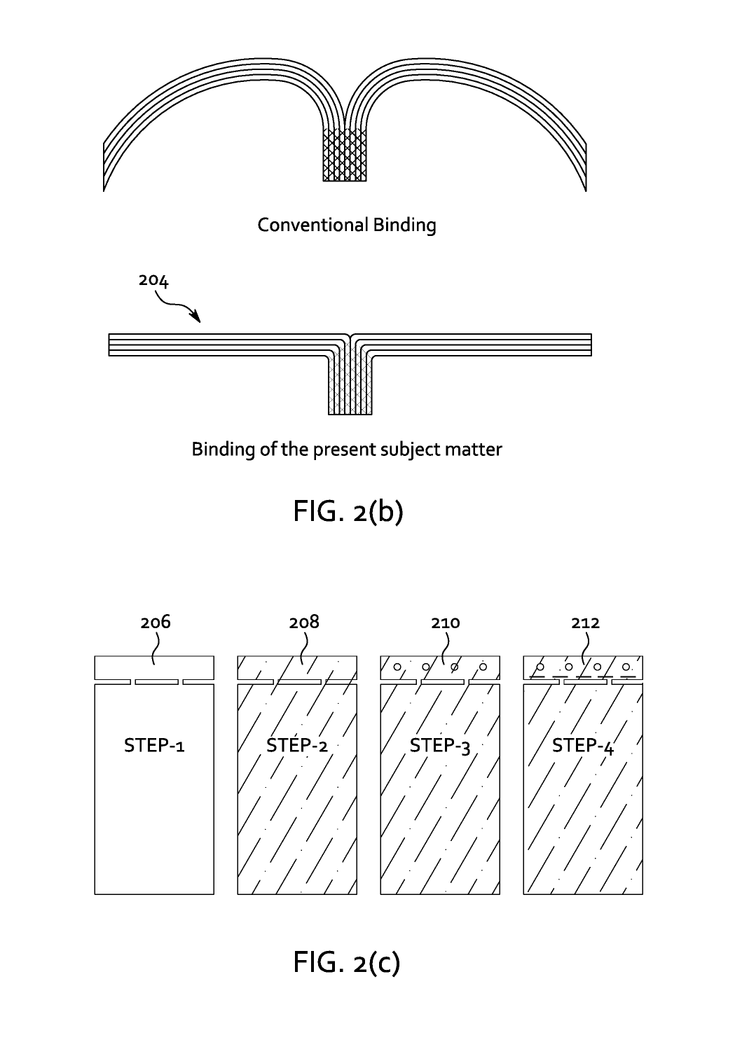

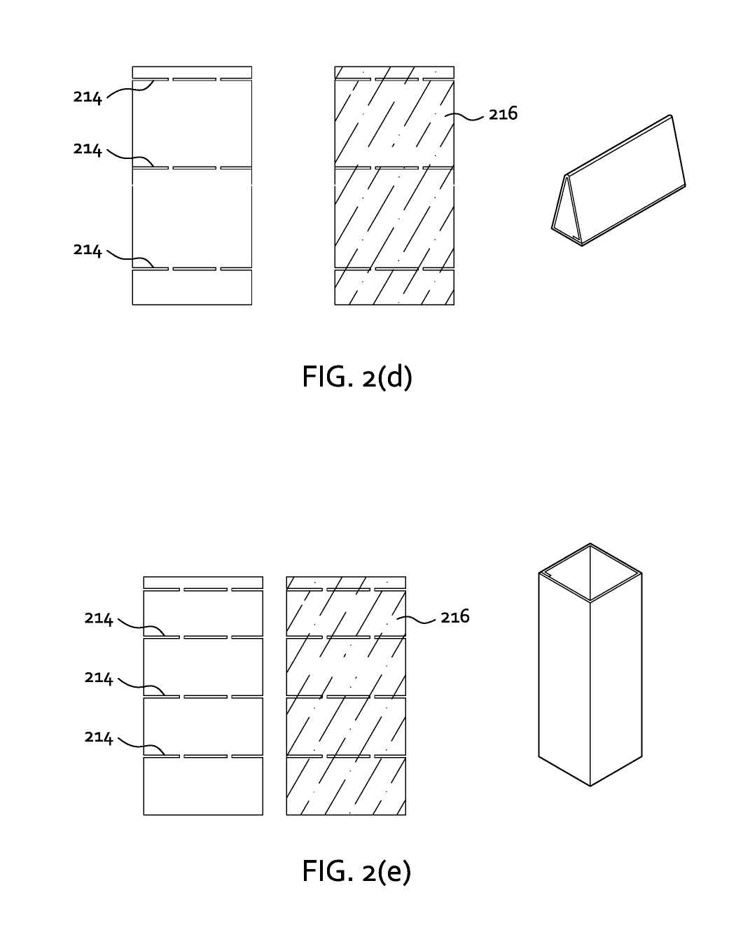

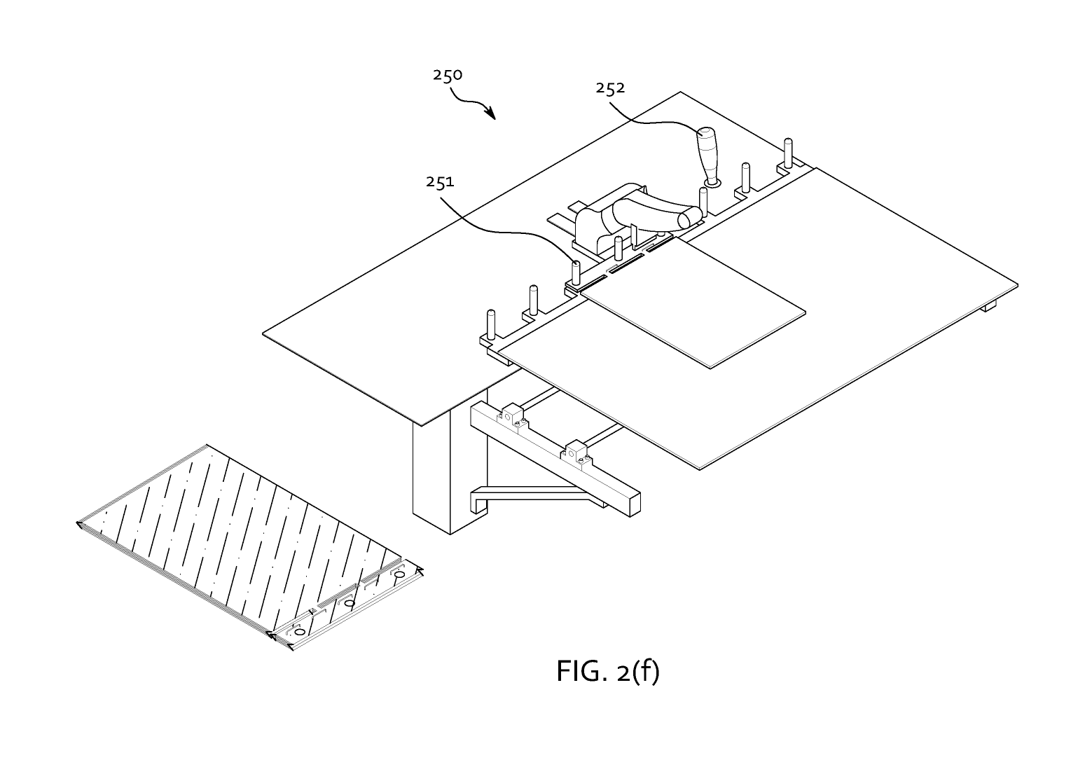

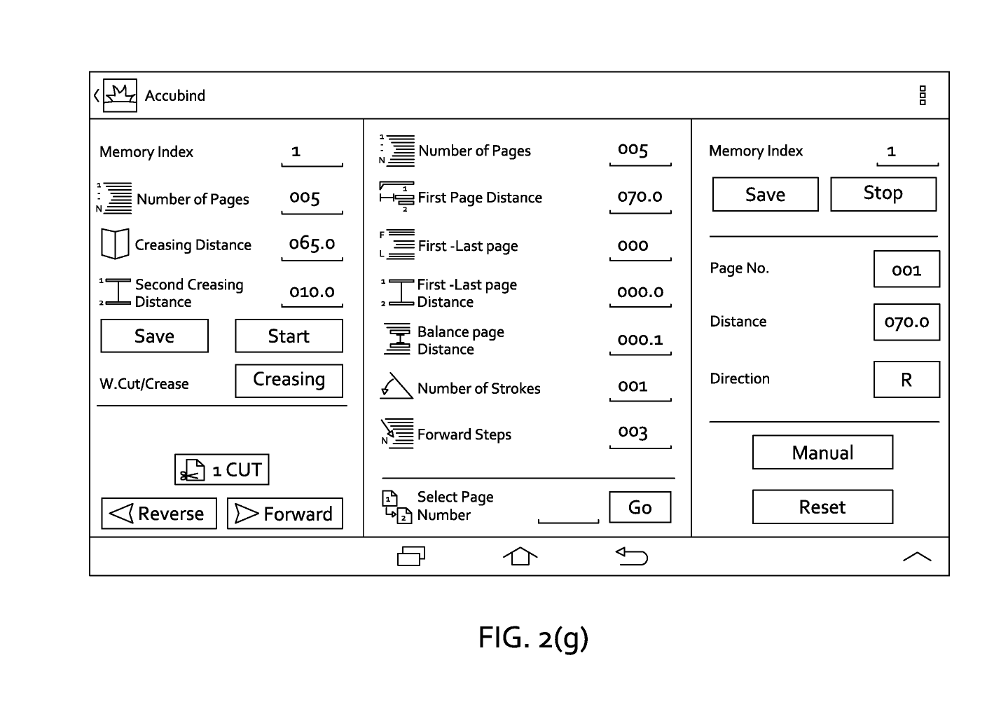

FIG. 2 shows a representation of a machine 200 according to an embodiment of the present subject matter. According to this embodiment, the machine 200 comprises a table 201, a first end 203, a feeder 205, a cutting tool 207, a laminator 209, a lamination film 213 and a punching tool 211.

At the first end 203 of the table 201 the feeder 205 is provided. The feeder 205 may also include a tray, and plurality of rollers and a paper guide angle for holding a bundle of sheets. The feeder 205 is configured to receive a bundle of sheets and is configured to move one sheet at a time from the bundle of sheets. In one embodiment, the bundle of sheets may consist of papers. The feeder 205 feeds the sheet (also referred interchangeably as a paper or a page) for processing and/or folding and/or punching and/or creasing etc. It shall become clear to a person, after reading this specification that the paper or the sheet or the page referred in this specification is not limited to the paper, sheet, page per se, but also includes cardboard, cloth or any other material that is required to be bound. In one embodiment, the feeder 205 may be manually operated. In some embodiments the feeder 205 may be operated by a processor. In an embodiment, the feeder 205 may include a roller and a sensor. The roller and a sensor in such cases may be controlled by the processor.

The processor is configured to receive a number of inputs that are also referred to as a first input. In one embodiment, the processor is coupled to a control panel. In one embodiment, the control panel may include a display. The control panel is configured to receive the first input. The first inputs may include, but not limited to: number of sheets in the bundle, type of desired cut or fold, thickness of each sheet, distance of pages from spine while binding the papers, sheets, card board etc, wherein spine is collective edge of each sheet when stacked together. In some embodiments, the spine of bundle of sheets is proximal edge along which the bundle of sheets is bound. An embodiment of a display and a number of inputs are shown in FIG. 2(g). The display 220 of the FIG. 2(g) or the control panel thereof of may be provided with an inputting means such as keyboard or touch screen etc. The first input received at the control panel may be received through the display. In some embodiments, the display has a touch sensitive screen. In some other embodiment, the display is a portable device, which communicates with the processor wirelessly. The processor includes memory and the control panel includes options to save input/s received at the control panel in a memory. The display may be used for displaying. Based on the first input, the processor determines length from an edge of a sheet at which a cut or a fold is desirable.

The bundle of sheets may be placed in a tray for feeding, the feeder 205 moves the papers for punching and/or creasing and/or folding or for an operation as may be required according to the present subject matter. The sensor detects an edge of the sheet, and provides an input corresponding to the detection of the edge to the processor. The processor causes the roller to rotate to cause selectively picking up of a sheet from the bundle of sheets for positioning the sheet for an operation. Picking up of the sheet may be referred to as feeding of the sheet for position and operation by the feeder. The amount of rotation of the roller depends on the distance at which the cutting and/or punching and/or folding and/or creasing is required to be done. The sheet moves along with the rotation of the roller and the amount of rotation provides length that the sheet travelled. This is how the processor determines different positions on the sheet. In one embodiment, when the sheet is positioned, the processor may actuate a pneumatic system to operate a cutting tool 207. In one embodiment, the sheet may stop once positioned, while in other embodiment, the processor may cause the operation substantially simultaneously with positioning without requiring the sheet to stop for the operation. The cutting tool 207 falls on the sheet and causes a cut in the sheet. It shall become clear to a person, that FIG. 2 shows the cutting tool 207, however, where the sheet requires folding, the cutting tool 207 may be replaced with a folding/creasing tool. Similarly, the cutting tool 207 may also be replaced by one or more punching tools. Providing a machine that may perform operations in the manner of present subject matter provide flexibility, in that, a number of operation may be performed on a sheet at a different locations by a tool without requiring manual feeding of the sheet multiple times. One example of such multiple operations is shown in FIG. 2(e).

According to an embodiment, the sheet may further move along the table. One or more additional rollers may be employed for moving the sheet along the table. In some other embodiment, the table 201 may include a conveyer system. In one embodiment, the sheet reaches a laminator 209, the sheet may get laminated and regain some of its strength that may have been lost due to the cutting of the sheet. The laminator 209 comprises a lamination film 213. Further, the lamination may also provide extra finish to the sheet. It shall become clear to a person skilled in the art that in some embodiment the subject matter may be practiced without the lamination of the sheet.

The sheet may further move to the next stage on the table 201 at a punching tool 211 where the sheet may be punched. The processor may position the sheet based on the edge detected by the sensor and the rotation of the rollers. Once the paper is positioned the processor may actuate the punching tool 211 in the similar manner as it was achieved at the cutting tool 207. The position of the sheet at which the sheet is to be punched is determined based on the input received at the control panel. In some other embodiment, the position at which the sheet is to be punched is determined in such a manner that when punched positions of the sheets are aligned, the edges of the sheets align themselves obliquely. It shall become clear to a person, after reading this specification, that in some embodiments, the cutting and punching and folding or combination thereof may be performed in a single pneumatic operation. Subsequently all the sheets of the bundle of sheets may be than collected and stapled together. In some other embodiments, the sheets may be collected and arranged for stapling and the processor may cause stapler to staple the sheets. Providing a machine that may perform operations in the manner of present subject matter provide flexibility, in that, a number of different operation may be performed on a sheet by a number of different tools without requiring manual and multiple feeding of the sheet multiple times. In some embodiments, the processor of the present subject matter may be configured to selectively actuate only those tools which are desired. For example, in some cases, only creasing is required, than other tools such as cutting tool 207, laminator 209 and punching tool 211 may be actuated for not performing any operation.

A location of the cut on a sheet may be controlled substantially accurately according to the present subject matter. This enables adjusting the location of a window cut and/or punching a hole on each of the sheets that need to be bound together. The present subject matter provides successively adjusting the position of the window cut on each of the papers. The successive adjustment of the window cut position on each sheet is such that when the sheets are stacked and the window cuts are aligned, the edges of the sheets form a substantially non-linear profile. In some embodiments, the substantially non-linear profile is a V-shaped profile. Some other embodiment the non-linear profile is substantially V-shaped and/or substantially U-shaped or substantially C-shaped profile. It shall become clear to a person, after reading this specification, that the non-linear profile formed by the edges of the stacked sheets may be achieved by successively adjusting the location of hole on each of the sheets. That is to say that the present subject matter is not limited to successively adjusting window cuts alone. In some embodiments, any one or both of holes and window cuts are successively adjusted on each of the sheets.

FIG. 2(a) shows a non-linear profile (of spine) 210, 212 of a bundle of sheets according to an embodiment of the subject matter. Binding papers in this manner helps in providing a substantially flat layout upon opening. That is to say, that the bulge in middle of a book opening of the book is substantially reduced. Further the dashed lines 214 represent window cut on each sheet. Similarly FIG. 2(b) shows an example of comparative results of the binding the bundle of sheets according to in the subject matter and conventional art.

FIGS. 2(c), 2(d) and 2(e) illustrate some of embodiments of punching and creasing of sheets of a bundle of sheets according to the present subject matter. In that FIG. 2(c) shows the sheet having window cut 206. The window cut sheet is laminated wherein hashing 208 indicates the lamination. Holes 210 are punched on the laminated sheet. At a further stage once all the sheets are have been processed, the sheets may be stacked together and stapled 212. In one possibility the sheets are stacked and aligned along the holes of each sheet, and therefore resulting in a non-linear spine, as discussed above. FIG. 2(d) illustrates one embodiment of obtaining a triangular shaped block from a sheet in that, the sheet may receive three window cuts 214 and subsequently laminated 216. FIG. 2(e) shows an embodiment of obtaining a rectangular block using window cuts 214 and subsequently laminating 216 in the subject matter. It shall become clear to a person, the order of the operations may be reversed or some operations may be omitted.

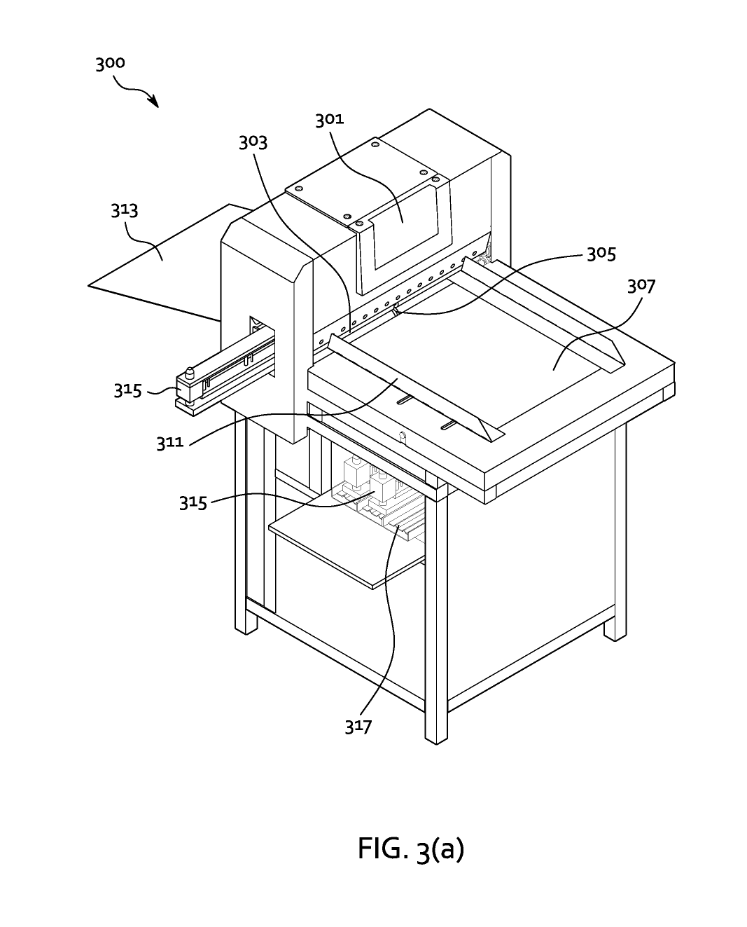

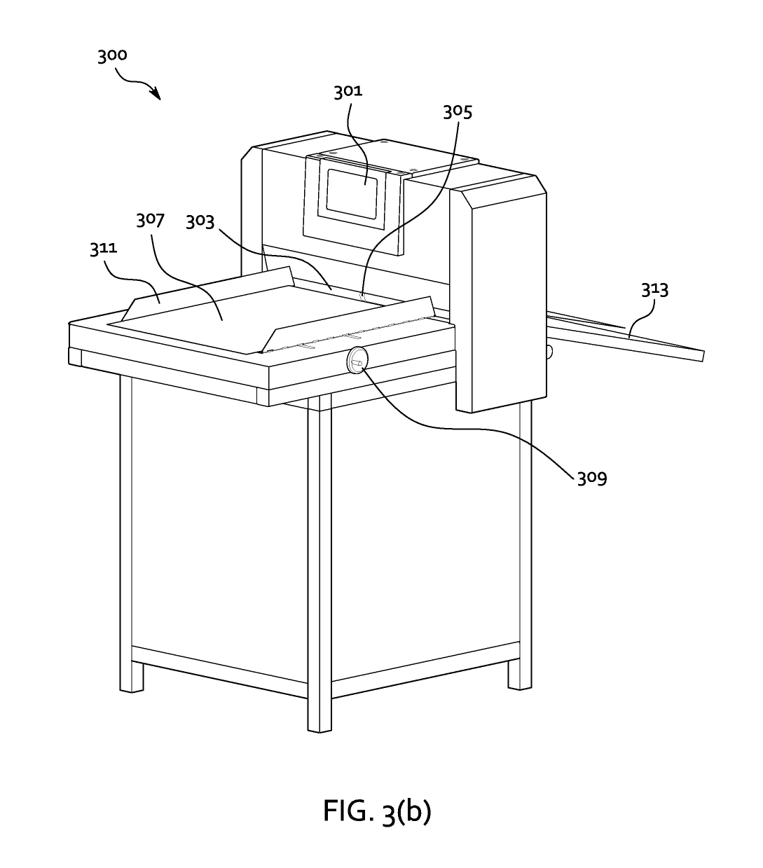

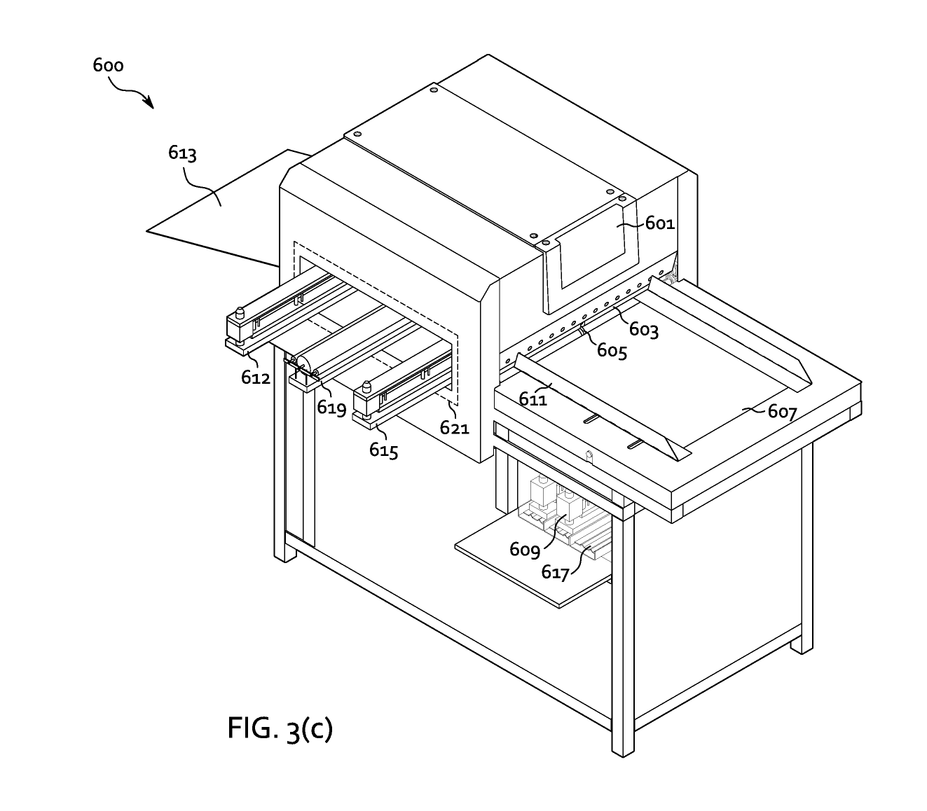

Subsequent detail makes reference to FIG. 2(g) for more details of a first input and control panel 301 of FIG. 3(a) or 601 of FIG. 3(b). In some embodiments, the first input includes instruction to execute a desired operation/s. In the FIG. 2(g), the text “sheet” is used interchangeably with the text “page”. The FIG. 2(g) shows a number of inputs and options that a control panel 301 or 601 may provide. As may be apparent that the control panel may include a controller or a processor and memory and provide the inputs received at the control panel 601 the interface shown in FIG. 2(g) to the processor. In some other embodiments, the control panel 601 may be part of a processor.

As may be apparent from FIG. 2(g) that the control panel may received inputs relating to: Number of Pages; Creasing Distance; Second Creasing Distance; First Page Distance; First-Last page; First-Last page Distance; Balance page Distance; Number of Strokes; and Forward Steps. Further the control panel may provide options to save configuration of a binding or cutting project. Further options for selection of operation for specific number of page by providing Select Page Number. In some other options, for a given page number and distance and direction of punching/creasing/cutting the tools may be accordingly selected and the operation is performed at a location specifically determined for the given page number. In some other embodiments, the reset function may be provided to clear any previous setting. In some other embodiments, manual function selection option may be provided. In some other embodiment, the machine may be configured to perform one or more of cutting, folding, laminating, and punching once the first input is received at the control panel. It shall become clear to a person, after reading this specification, that Creasing Distance and Second Creasing Distance may also include options to receive more subsequent creasing distance if multiple creasing is required to be performed on a single sheet.

It shall become clear that First Page Distance indicates distance at which the first crease, cut or punch is desired at first page from an edge of the first page. Further for a given operation on a first page and a last page, desired amount shift of the location of the operation on each of the first page and last page is indicated by First-Last Page. The First-Last page Distance indicates distance between the first page and last page. The distance may determined by multiplying total number of pages with thickness of each page if each page is of same thickness. Alternatively the distance may be determined by summing thickness of the pages and this operation may be done by a processor. This would effectively give thickness of the bundle. In another alternate, the First-Last page Distance may be a distance that a user defines, without regards to number of pages in the bundle. Balance page Distance provides shift of location of the operation that is desired on successive pages for an operation. In some embodiment, the shift may be desired on each alternate page or only on selected pages. Number of Strokes and Forward Step may be provided for further customizing the operations.

FIG. 2(f) shows a stapling machine 250. It shall become clear to a person, after reading this specification, that the stapling machine 250 may be disposed along with the other tools 207, 209, 2011 with the machine 200 of FIG. 2. However in such embodiment, it is apparent that provisions for manual handling of the stapling machine 250 may be removed for cost saving. Further the sheets in such embodiment of 200 may be collected and aligned along the holes through studs 251. More details to the stapling machine 250 shall become clear in the following discussion. In one embodiment, the stapling machine 250 may be located at the end of the table 201 illustrated in FIG. 2. In the stapling machine 250 (also referred to as the stapler 250) the sheets of a bundle of sheets that need to be stapled may be inserted into guiding studs 251. Once the sheets are secured at proper position, a pneumatic lever 252 may be actuated to staple the sheets of a bundle of sheets. In one embodiment, the pneumatic lever may be operated manually. In another embodiment, the insertion of sheets into guiding studs and the operation of pneumatic lever may be performed by a processor. The insertion of sheets and the operation of pneumatic lever in such cases may be controlled by the processor. Further, in some cases, to remove the non-linear profile subsequent to stapling, part of the spine may be sliced or cut.

FIG. 3(a) and FIG. 3(b) show another embodiment of a machine according to embodiments of the present subject matter. In that FIG. 3(a) shows a machine 300, a control panel 301, a roller 303, a sensor 305, a tray 307, a knob 309, a paper guide angle 311, a collecting tray 313, a plurality of tools 315 and a tool rack 317. The machine 300 further comprises a processor and a drive system (not shown). The drive system may be a lever based pneumatic system or a motor based system (not visible in FIG. 3(a)). Further reference is also made to FIG. 2(g) for the details of the control panel 301 and details of a first input.

Functioning of the machine 300 is substantially similar to that discussed with respect to the embodiment 200 shown in FIG. 2. Except that the machine provides more details in regards with selection of tools, wherein the tools 315 may be housed in a tool housing or tray 307, from where the tools 315 may be selected by the processor and moved for operation from the tray 307. In some embodiments, the plurality of tools 315 is disposed in the tool housing and processor selects and engage one tool of the plurality of tools 315 for the operation. The control panel 301 may comprise a display. The control panel 301 may comprise an input device such as a keyboard (not shown in the figure) for entering the inputs for the operation of the machine 300. In some embodiments, the display is provided with a touch screen and in some other embodiments, the control panel 301 may be detachable and operable wirelessly by employing near field or far field communication protocols such as Bluetooth™, Wi-Fi™, phones, Short Messaging Systems (SMS) etc.

According to this embodiment, a bundle of sheets may be placed on the tray 307. The bundle of sheets may be held in place by adjusting the paper guide angle 311. The knob 309 is provided to adjust the paper guide angle. In one embodiment, the paper guide angle 311 may be adjusted manually. In another embodiment, the paper guide angle 311 may be adjusted using the processor. Plurality of rollers 303 may be provided to selectively feed one sheet at a time for an operation by the machine 300. In this embodiment, the tray 307, the rollers 303 and the paper guide angle 311 may collectively be called as a feeder.

The sensor 305 is provided to sense an edge of a sheet and align the edge before an operation by the machine 300. In some embodiments, the sensor 305 is configured to sense a sheet. In one embodiment, the sensor 305 may be an optical sensor. In some other embodiment, the sensor 305 may be an optical fiber based sensor. In some other embodiments, the sensor 305 may be a sonic sensor. It shall become clear to a person skilled in the art after reading this specification, that the sensor 305 of the present subject matter may be replaced by any other sensor than the sensors discussed in the above embodiments, so long as the sensor is capable of detecting an edge of a sheet. In some embodiments, the sensor 305 detects the sheet per se.

According to this embodiment, the machine 300 is provided with a tool housing in which the plurality of tools 315 may be removably disposed. In some embodiments, the tool housing may include the tool rack 317. The processor may be configured to select a tool of the plurality of tools 315 from the tool housing/the tool rack 317 which may house a number of tools. For example, the tool rack 317 may house a tool for window cutting, another tool for punching, a tool for laminating, and yet another tool for folding and/or creasing etc. The processor may be configured for selecting one tool or may be configured for selecting a number of tools. The tools may be selected simultaneously or sequentially. In some other embodiment, the processor may select more than one tool in a single pneumatic (pressing) operation, achieving number of actions in a single operation cycle some examples of result of such multiple action is shown in FIG. 2(d) and FIG. 2(e). It may be noticed that the present subject matter provides performing of such number of operations on a sheet without having to feed the same sheet number of times. In some embodiment, one tool of the plurality of tools 315 may be selected as desired.

In one embodiment, the plurality of tools 315 includes a laminator (not shown in the diagram). In one example, the function of the laminator is to laminate the sheets one at a time after a window cutting operation and before a punching operation as configured by the processor. The lamination operation may be necessitated to provide extra strength and finish to the sheets.

FIG. 3(c) shows an embodiment of a machine 600 according to another embodiment of the present subject matter. The machine 600 comprises a control panel 601, a tray 607, a plurality of rollers 603 (also referred to as roller 603), a sensor 605, a tool housing 621, a tool rack 617, a plurality of tools 609, 619, 613 and 615, a paper guide angle 611, and a collecting tray 613.

The machine 600 also includes a processor, one or more pneumatic systems, motors, drive systems and a feeder. The following discussion also refers to a bundle of sheets and the sheets thereof, a sheet, a first sheet, a first edge, a second sheet, a second edge, a first location, and a second location—although some elements are not shown in the FIG. 3(c), more details in respect of these elements shall become clear to a person, after reading this specification. Furthermore the following discussion also refers to operations such as a window cutting operation, a punching operation, a stapling operation, a folding operation, a creasing operation, a lamination operation etc.

The machine 600 is provided with the processor. The processor is a control device configured to cause performance of a plurality of operations on the bundle of sheets and the sheets thereof. Each operation corresponds to at least one tool of the plurality of tools 609, 619, 613 and 615. The processor may be coupled to the pneumatic systems and the pneumatic systems may in turn be coupled to the plurality of tools 609, 619, 613 and 615 and the plurality of rollers 603. The plurality of tools 609, 619, 613 and 615 are configured to operate on the bundle of sheets and sheets thereof. The plurality of operations includes the window cutting operation, the punching operation, the stapling operation, the folding operation, the creasing operation etc. Each of the plurality of tools 609, 619, 613 and 615 may be employed for different operations as stated above.

The processor is configured to receive the first input as discussed with reference to FIG. 2(g). The processor is configured to cause performance of the one or more operations of the plurality of operations by actuating at least one tool of the plurality of tools 609, 619, 613 and 615. In some embodiments the plurality of tools 609, 619, 613 and 615 may be actuated using pneumatic levers or actuators. In some other embodiments, the plurality of tools 609, 619, 613 and 615 may be actuated by a motor. The at least one operation of the plurality of operations is performed on the bundle of sheets collectively or on the sheets thereof separately. The operation is performed based on the first input. The bundle of sheets comprises at least the first sheet and the second sheet. The processor is configured to receive the first sheet and the second sheet respectively. The processor is configured to compute and determine the first location on the first sheet and the second location on the second sheet. The processor determines the first location and the second location based on the first input. The first sheet has the first edge and the second sheet has the second edge. The first location and the second location are determined by the processor such that, when the first location and second location are aligned or overlapped on each other the first edge and the second edge align-obliquely. Effectively resulting in a V-Shaped or a non-linear profile of spine of the bundle of sheets. The operation is performed on the first location on the first sheet and the second location on the second sheet.

In some operation, e.g. the window cutting operation, the processor may determine the first location and second location such that when the first location and the second location are aligned the first edge and the second edge are also aligned. In some other operations the processor may not determine the first location and the second location but uniformly perform the operation through the sheet, such example of operation may be lamination operation.

One objective of window cutting on a sheet is to provide flexibility to the sheet at a location from where it is likely to be folded upon biding and browsing through the book of bound sheets. While cutting window does provide desirable flexibility to the sheet, however at the same time it also weakens the sheet, therefore according to one aspect the subject matter provides strengthening the sheet by laminating the sheet subsequent to window cutting the sheet. Lamination may provide additional finish and texture to the sheet in addition to the strength. This is possible because, lamination generally deploys thin plastic sheet which has relative higher strength, durability and flexibility.

The processor is configured to selectively receive a sheet and position the sheet for causing the operation to be performed on the sheet. The sheet is positioned according to the first location and the tool is selected by the processor for performing the operation. The processor positions the sheet selected for the operation based on an edge detected by the sensor 605 and by actuating the plurality of rollers 603. The processor may compute and store step by step instructions to operate the plurality of tools 609, 619, 613 and 615, and rollers 603. In some embodiments, the processor comprises a microprocessor, memory and input/output interfaces. In some other embodiments, the processor may be configured as a firmware or a hardware or a computer system with a CPU (central processing unit), memory and interfaces for input/output. In some embodiments, the processor may be remotely controlled. In some other embodiments, the processor may be provided the first input using a remote location using a wired or a wireless communication. The processor is coupled to the feeder, the sensor 605, the plurality of tools 609, 619, 613 and 615 and the control panel 601. The processor is configured to receive the first input through the control panel 601. In some other embodiments, the control panel 601 may be located at a remote location.

The processor is coupled to the control panel 601 and the control panel 601 is configured to receive the first input. The control panel 601 may comprise a display. The control panel 601 may comprise an input device such as a keyboard (not shown in the figure) for entering the first input. In some embodiments, the display is provided with a touch screen and in some other embodiments, the control panel 601 may be detachable. In some other embodiments, the control panel 601 is operable wirelessly from a remote location. In further embodiments, the control panel 601 may employing near field communication protocols or far field communication such as Bluetooth™, Wi-Fi™ or other electromagnetic wave communication protocols.

The first input according to one embodiment, characterizes the bundle of sheets and the sheets thereof. On example shown in FIG. 2(g) is a display and the first input that may be received through the display. For more details, the first input FIG. 2(g) and corresponding description may be referred.

According to one embodiment, the machine 600 is provided with the tray 607. The tray 607 may be used for placing the bundle of sheets. The machine 600 is provided with the paper guide angle 611.The tray 607 is configured to receive the bundle of sheets. The paper guide angle 611 is adjustable to accommodate according to the size of the sheets in the bundle of sheets. The machine 600 is provided with the plurality of rollers 603. The plurality of rollers 603 may be configured to selectively feed at least one sheet at a time for an operation by the machine 600. The tray 607, the paper guide angle 611 and the plurality of rollers 603 together forms the feeder. The feeder is coupled to the processor and the sheets may be positioned for operations by the feeder and the processor. The bundle of sheets may be held in place by adjusting the paper guide angle 611. The processor may be configured to adjust the paper guide angle 611 to suit the width of the bundle of sheets. In one embodiment, the paper guide angle 611 may be adjusted manually.

The machine 600 is provided with the sensor 605. The sensor 605 is provided to sense an edge of a sheet of the bundle of sheets in order to prepare the sheet for the operation by the machine 600. Once the sensor 605 detects the edge, the processor may actuate the plurality of rollers 603 to position the sheet for the operation based on the detection. The movement and positioning of the sheet at a location for operation by the plurality of tools 609, 619, 613 and 615 are enabled by the plurality of rollers 603. In some embodiments, the sensor 605 is configured to sense the sheet. In one embodiment, the sensor 605 may be an optical sensor. In some other embodiment, the sensor 605 may be an optical fiber based sensor. In some other embodiments, the sensor 605 may be a sonic sensor. It shall become clear to a person skilled in the art after reading this specification, that the sensor 605 of the subject matter may be replaced by any other sensor than the sensors discussed in the above embodiments, so long as the sensor 605 is capable of detecting an edge of a sheet.

According to this embodiment, the machine 600 is provided with the tool housing 621. In some embodiments, the tool housing 621 also includes the tool rack 617. The tool rack 617 is configured to host the plurality of tools 609, 619, 613 and 615. In some embodiments, the plurality of tools 609, 619, 613 and 615 are removably disposed in the tool housing 621. In some other embodiments each tool of the plurality of tools 609, 619, 613 and 615 corresponds at least an operation of a plurality of operations. For example, the plurality of tools 609, 619, 613 and 615 may include any one or a combination of a punching tool, a window cutting tool, a laminator, a creasing tool, a folding tool, and a stapler. The plurality of operations includes any one or a combination of: a window cutting operation, a punching operation, a stapling operation, a creasing operation a folding operation, and a lamination operation. The correspondence may be such that the punching tool corresponds to the punching operation, the window cutting tool corresponds to the window cutting operation, the laminator corresponds to the lamination operation, the creasing tool corresponds to the creasing operation, the folding tool corresponds to folding operation, and the stapler corresponds to stapling operation. In some embodiments, each tool of the plurality of tools 609, 619, 613 and 615 is arranged to perform the operation on the sheet. In some other embodiment, the tool rack 617 may host tools that are not in operation. The processor may be configured to select a tool from the plurality of tools 609 from the tool rack 617. In another embodiment, a tool for folding and/or creasing 609 may be housed in the tool rack 617 as shown in FIG. 3(c). The tool housing 621 may house the plurality of tools 609, 619, 613 and 615 that are coupled to the processor and are ready for operations. In some embodiments, the plurality of tools 609, 619, 613 and 615 are disposed removably in the tool housing 621. In one embodiment, the tool housing 621 may house a tool for window cutting 615, a tool for laminating 619, and yet another tool 612 for punching holes and some other tools not shown in the FIG. 3(c). In another embodiment, a tool for folding and/or creasing may be housed in the tool housing 621. The processor may be configured for selecting one tool or may be configured for selecting a number of tools simultaneously or sequentially. In some other embodiment, the processor may select more than one tool in a single pneumatic (pressing) operation, achieving a number of actions in a single operation cycle. In some embodiment, plurality of tools 615 may be available to be selected manually and placed in the tool housing 621.

In one embodiment, the machine 600 is provided with another tool 619 for lamination which is termed as a laminator 619. The function of the laminator 619 is to laminate the sheets one sheet at a time after the window cutting operation in order provide extra strength and finish to the sheets. Cutting a window in a sheet results in removal of part of sheet and therefore the sheet losses some strength, laminating the sheet after cutting the window reinforces the strength of the sheet. The laminator 619 is another tool that is coupled to the processor and operable by the processor. The lamination operation may be inserted by the processor in a sequence of operations such as window cutting, lamination and punching. In one embodiment, one or more operations may be combined in one operation and performed by the processor.

In one example, the machine 600 is configured to cause window cutting, followed by lamination and followed by punching hole or holes operations. In one example, the window cut made by the tool 615 on all the sheets such that upon aligning the window cuts, edges of each sheet are also aligned. The window cutting operation is followed by a lamination operation on the sheet using tool 619. At this stage the sheet is laminated, providing strength that the sheet may have lost due to the window cutting operation. The lamination operation is followed by a hole punching operation. In that, one or more holes are punched on the sheet using the tool 612. As explain earlier the holes are punched on the sheet such that when holes of sheets are aligned the spine forms a non-linear profile. Once all the sheets of the bundle of sheets have undergone the above operations, the sheets may be stacked together, and holes of each sheets are be aligned and bundle is stapled. Aligning of the holes may be performed by inserting the stud 251 of FIG. 2(f) through the holes. According to one example, each sheet of the bundle of sheets undergoes window cutting operation at a fixed location. That is to say, when the edges of the sheets are aligned the window cuts are also aligned.

The processor is configured to determine a location for window cut and a location for punching hole substantially accurately and positions the tool/s and/or sheet/s for operation according to these locations. The processor is further configured to cause performance of the operations at respective locations. This enables adjusting the location of a window cut and punching a hole on each of the sheets that need to be bound together. In one embodiment, the subject matter provides successively adjusting the location for the window cut on each of the sheet. In other embodiment, the subject matter provides successively adjusting the location for punching hole. In some other embodiment the subject matter provides successively adjusting both the locations i.e. location for punching hole and location for window cut. In one embodiment successive adjustment of the aforementioned locations each sheet is such that when the sheets are stacked and the window cuts of each sheet are aligned, the edges of the sheets form a substantially non-linear profile or the edges are obliquely aligned. In one embodiment successive adjustment of the aforementioned locations each sheet is such that when the sheets are stacked and the holes of each sheet are aligned, the edges of the sheets form a substantially non-linear profile or the edges are obliquely aligned. In an embodiment, the edges of the sheets form a ‘V’ shaped profile at the binding end of the bundle of sheets as illustrated in FIG. 2(a). It shall become clear to a person, after reading this specification, that the non-linear profile formed by the edges of the stacked sheets may also be achieved by successively adjusting the location of the holes sheets of the bundle of sheets and aligning the holes. That is to say that the subject matter is not limited to successively adjusting window cuts or holes alone. In some embodiments, both the holes and the window cuts are successively adjusted.

In one embodiment, the plurality of tools 619, 613 and 615 collectively fixed on a bench and the bench along with the plurality of tools may be disposed into the tool housing 621. In another embodiment, the stapler 250 shown in the FIG. 2(f) is coupled at the collecting tray 613 where sheets are collected and each hole that is punched on the sheets is inserted into the guiding studs 251 and the processor is configured to actuate the stapler to cause stapling of the bundle of sheets. In some other embodiments, the machine is provided with an edge cutter (not shown) the edge cutter may cut edges of the sheet to provide final finish. Cutting edges of the sheet may remove any non-linear profile that the sheets may form upon stacking the sheets.

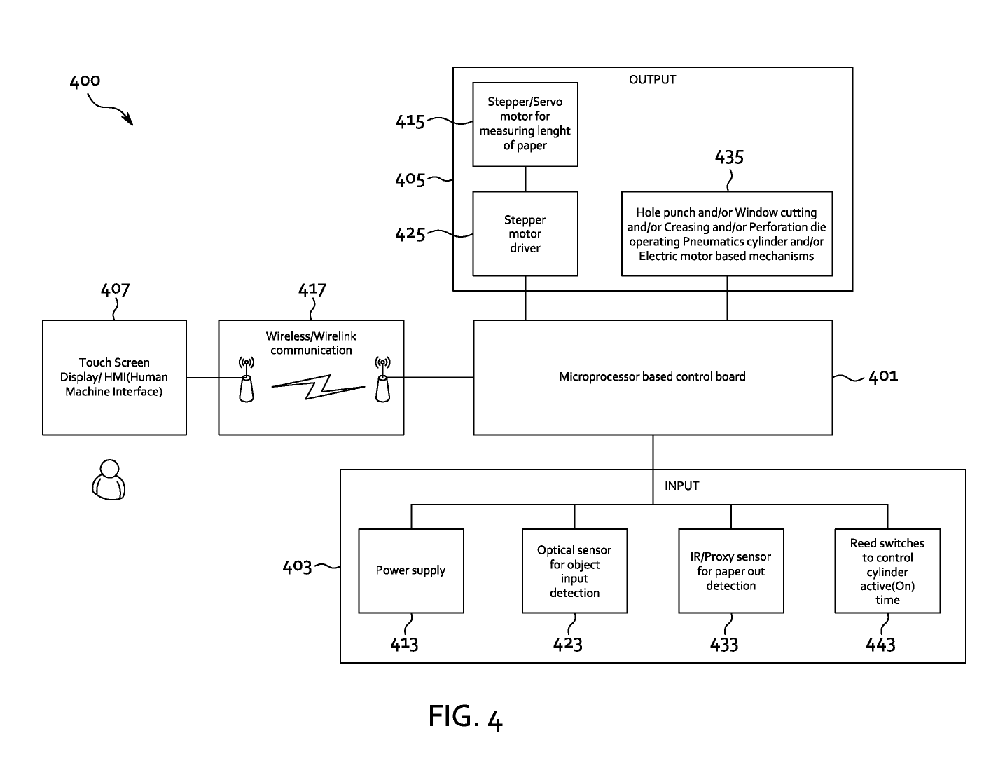

FIG. 4 shows a block diagram 400 of the subject matter. The block diagram 400 shows coupling of the processor 401 according an embodiment of the present subject matter. In one embodiment, the processor 401 is coupled to an input block 403, an output block 405 and a control block 407. In some embodiment, the control block 407 may be coupled to the processor 401 through a wired communication. In some other embodiments, the control block 407 may be coupled to the processor 401 or through a wireless communication block 417. The control block 407 includes a control panel. The control panel may include a display. In some embodiments, a user may supply inputs to the processor 401 using the display. Based on the inputs received at the processor 401, processor accordingly determines desired actions.

The input block 403 includes a power supply 413 which supplies the power to the processor 401. In some embodiments, the machine 400 may receive power from the power supply 413. In some embodiments, the input block 415 includes an optical sensor 423. The optical sensor is a sensor to detect objects. It should be understood that the sensor may be a sensor other than an optical sensor. The some other embodiments, the input block 403 include an IP/Proxy Sensor for sheet detection. The reed switches to control cylinder active on time 443.

The output block 405 includes a motor driver 425, a hole punch and/or window cutting and/or creasing and perforation die operation pneumatic cylinder and/or electric motor based mechanisms 435 and a stepper/servo motor for measuring length of sheet 415. The output blocks 405 may include one or more actuators and motors controlled by the processor 401. In some embodiment the motor is stepper motor and the motor driver 425 is stepper motor driver.

The present subject matter provides a method that may be practiced at the processor 401. The present subject matter also provides a method of configuring the processor 401. The present subject matter also provides a method practiced at the machine 400. The subject matter also provides a method for manufacturing the machine 400.

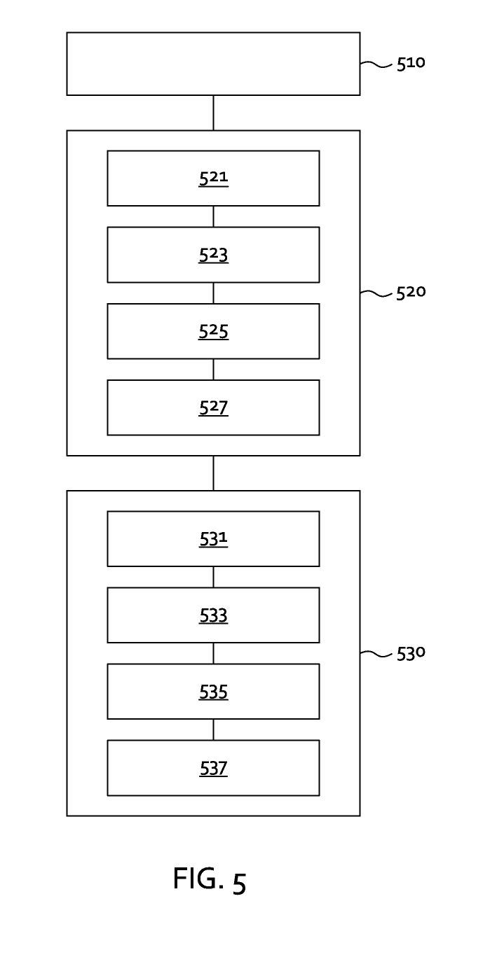

FIG. 5 shows an embodiment of a method 500 for manufacturing the machine according one embodiment of the present subject matter. The method includes, at block 510 the processor is configured. In one possibility, the processor may be configured to receive a first input. The first input according to one embodiment, characterizes a bundle of sheets and the sheets thereof. For more details in respect of the first input FIG. 2(g) may be referred. The processor at block 510 is further configured to determine a first location on a first sheet and a second location on a second sheet based on the first input. The first location and the second location are so determined that after aligning the first location and the second location, a first edge of the first sheet and a second edge of the second sheet align in an oblique manner or appear as a non-linear profile. The processor is further configured to cause performance of an operation on the first location and the second location.

At block 520, according to another aspect of the present subject matter, the processor is coupled to a number of elements. At block 521, the processor may be coupled to a feeder, at block 523 the processor may be coupled to a sensor and plurality of rollers, at block 525 the processor may be coupled to control panel and at block 527, the processor may be coupled to a plurality of tools. The plurality of tools may include a punching tool, a window cutting tool, a laminator, a creasing tool, a folding tool, a stapler etc.

At block 530, 531 the processor may be configured to control the feeder. The feeder is configured to receive a bundle of sheets and feed selectively a sheet of the bundle of sheets to position the sheet as required by the processor. At block 533, the processor may be configured to receive a signal from the sensor, the sensor may be configured to detect a sheet and provide the signal to the processor based on detection. The processor, at block 533, may be further configured to cause movement of plurality of rollers, for positioning the sheet. At block 535, the processor may be configured to receive the first input through the control panel. The control panel is configured to receive the first input and configured to convey the first input to the processor. At block 535, the processor may also be configured to receive the first input from a remote location through any one of a wired communication and wireless communication or a combination thereof. The processor is configured to determine the first location and the second location based on the first input. At block 537, the processor may be configured to control the plurality of tools. The plurality of tools may include a number of tools including the tools discussed with reference to FIG. 2, 2(f), 3(a), 3(b) and 3(c). The processor is configured to cause the operation on the sheet by actuating the plurality of tools. The processor is further configured to selectively operate the plurality of tools serially, discretely or substantially simultaneously. In one embodiment, the plurality of tools includes the laminator and the processor is configured to cause lamination of the sheet. Similarly, the plurality of tools include the punching tool and the processor is configured to cause punching of the sheet, the plurality of tools include the window cutting tool and the processor is configured to cause window cutting of the sheet, the plurality of tools include the stapler and the processor is configured to cause stapling of the bundle of sheet.

At block 521 may further include providing the feeder with a tray. The tray may include a paper guide angle and the bundle of sheets may be received in the tray and supported by the paper guide angle. At block 527 provides a tool housing in which the plurality of tools may be removable disposed. The tool housing may also be coupled to the processor and at block 537 the processor may be configured to selectively actuate the plurality of tools disposed in the tool housing. A tool rack may be provided with the machine for storing any one of or more of the plurality of tools, are not in operation.

While the subject matter may be susceptible to various modifications and alternative forms, specific embodiments have been shown by way of example in the drawings and have been described herein. Alternate embodiments may be practiced without departing from the spirit of the subject matter. While the drawings show some features of the subject matter, some features may be omitted. Alternatively, in some other cases some features may be emphasized while others are not. Further, the methods disclosed herein may be performed in manner and/or order in which the methods are explained. Alternatively, the methods may be performed in manner or order different than what is explained. However, it should be understood that the subject matter is not intended to be limited to the particular forms disclosed. The subject matter is to cover all modifications, equivalents, and alternatives falling within the spirit and scope of the subject matter as defined by following appended claims.

What is claimed is:

1. A machine comprising:
a sensor configured to detect a sheet of a bundle of sheets, wherein the bundle of sheets includes at least a first sheet having a first edge and a second sheet having a second edge, and the sheet is any one of the first sheet and the second sheet;
a plurality of tools removably disposed in a tool housing and each tool of the plurality of tools corresponds to at least an operation of a plurality of operations, and each tool of the plurality of tools is arranged to perform the operation on the sheet; and
a processor configured to position the sheet and to selectively actuate at least one tool of the plurality of tools to cause performance of at least one operation at a first location on the first sheet and at a second location on the second sheet, and wherein the first location and second location are determined by the processor based on a first input to obliquely aligned the first edge and the second edge upon aligning the first location and second location.

2. The machine of claim 1, further comprises a plurality of rollers configured to receive and position the sheet based on detection of the sheet by the sensor and the first input and the processor is configured to cause at least one roller of the plurality of rollers to roll to position the sheet.

3. The machine of claim 1, further comprises a feeder configured to receive the bundle of sheets, and the feeder is arranged to selectively feed the sheet for positioning.

4. The machine of claim 1, wherein the sensor includes any one or a combination of: an optical sensor, an electrical sensor, a mechanical sensor, and a sonic sensor.

5. The machine of claim 1, wherein the plurality of tools includes any one or a combination of a punching tool, a window cutting tool, a laminator, a creasing tool, a folding tool, and a stapler.

6. The machine of claim 1, wherein the plurality of operations includes any one or a combination of: a window cutting operation, a punching operation, a stapling operation, a creasing operation, a folding operation, and a lamination operation.

7. The machine of claim 1, wherein the processor is configured to receive the first input and wherein the first input characterizes the bundle of sheets and sheets thereof.

8. The machine of claim 1, wherein the processor is configured to receive the first input from a remote location through any one of a wired communication, a wireless communication and a combination thereof.

9. The machine of claim 1 further comprises a control panel, wherein the control panel is coupled to the processor and the control panel is configured to receive the first input.

10. A method of manufacturing a machine comprising:
configuring a sensor to detect a sheet of a bundle of sheets, wherein the bundle of sheets includes at least a first sheet having a first edge and a second sheet having a second edge, and the sheet is any one of the first sheet and the second sheet;
disposing removably a plurality of tools in a tool housing and each tool of the plurality of tools corresponds to at least an operation of a plurality of operations, and arranging each tool of the plurality of tools to perform the operation on the sheet; and
configuring a processor to position the sheet and to selectively actuate at least one tool of the plurality of tools to cause performance of at least one operation at a first location on the first sheet and at a second location on the second sheet, and wherein the first location and second location are determined by the processor based on a first input to obliquely aligned the first edge and the second edge upon aligning the first location and second location.

11. The method of claim 10, further comprises configuring a plurality of rollers to receive and position the sheet based on detection of the sheet by the sensor and the first input and configuring the processor to cause at least one roller of the plurality of rollers to roll to position the sheet.

12. The method of claim 10, further comprises:
providing a feeder to receive the bundle of sheets, and arranging the feeder to selectively feed the sheet for positioning; and
configuring the sensor includes configuring any one or a combination of: an optical sensor, an electrical sensor, a mechanical sensor, and a sonic sensor.

13. The method of claim 10, the method includes disposing any one or a combination of a punching tool, a window cutting tool, a laminator, a creasing tool, a folding tool, and a stapler and wherein the plurality of tools corresponds to a plurality of operations in that: the punching tool corresponds to a punching operation; a window cutting tool corresponds to a window cutting operation; a laminator corresponds to a lamination operation; a creasing tool corresponds to a creasing operation; a folding tool corresponds to a folding operation; and a stapler corresponds to a stapling operation.

14. The method of claim 10, the method includes configuring the processor to receive the first input and wherein the first input characterizes the bundle of sheets and sheets thereof.

15. The method of claim 10, wherein the method includes configuring the processor to receive the first input through any one of a wired communication, a wireless communication and a combination thereof and coupling a control panel with the processor, wherein the control panel is configured to receive the first input.
